(19) United States
(12) Patent Application Publication
(10) Pub. No.: US 2013/0050151 A1
(43) Pub. Date: Feb. 28, 2013

(54) TOUCH PANEL AND DYNAMIC CONTROL METHOD THEREOF

(71) Applicants: Yen-Hung Tu, Taipei (TW); Chung-Lin Chia, Taipei (TW); Wen-Chieh Pan, Taipei (TW)

(72) Inventors: Yen-Hung Tu, Taipei (TW); Chung-Lin Chia, Taipei (TW); Wen-Chieh Pan, Taipei (TW)

(73) Assignee: Rich IP Technology Inc., Taipei (TW)

(21) Appl. No.: 13/240,882

(22) Filed: Sep. 22, 2011

(30) Foreign Application Priority Data
Aug. 25, 2011 (TW) 100130445

(51) Int. Cl. G06F 3/041

(52) U.S. Cl. 345/178

(57) ABSTRACT

A dynamic control method for a touch panel, including the steps of: providing a dynamic resolution control circuit for configuring a touch panel to possess a first resolution and a second resolution; and providing an induced signal gain control circuit for configuring the touch panel to have a first gain corresponding to the first resolution, and a second gain corresponding to the second resolution, wherein, the resolution of the touch panel will change from the first resolution to the second resolution when an object is within a distance from the panel. In addition, the present invention further presents a touch panel system and a dynamic control method for adjusting the sensitivity of a touch panel.

### BACKGROUND OF THE INVENTION

1. Field of the Invention

The present invention relates to a dynamic control method for a touch panel, especially to a dynamic control method capable of adjusting the resolution, scan frequency, signal gain, or active condition of a touch panel.

2. Description of the Related Art

Ever since Apple's iPhone with a multi-touch function was delivered in 2007, touch screen products have taken the market by storm, and almost all mobile phones and tablet PCs have followed suit to provide a touch screen.

Please refer to FIG. 1(a)-1(c), which illustrate the operations of a prior art PCT (Projected Capacitive Touch) panel 200 by a finger 300 at distances D1, D2, and D3 respectively. For general operation method of the prior art PCT panel 200, the value of an induced signal, which can be a voltage or a current generated on an equivalent capacitor of a sensing area of the prior art PCT panel 200, can be divided into an inactive region, an unstable region, and an active region, with a threshold set above the unstable region and below the active region. As illustrated in FIG. 1(a), when the distance between the finger 300 and the prior art PCT panel 200 is D1, wherein an induced signal lower than the threshold is generated on an equivalent capacitor of a sensing area of the prior art PCT panel 200, the prior art PCT panel 200 will be inactive. As illustrated in FIG. 1(b), when the distance between the finger 300 and the prior art PCT panel 200 is D2 (D2<D1), wherein an induced signal higher than that induced by the finger 300 at D1 but lower than the threshold is generated on an equivalent capacitor of a sensing area of the prior art PCT panel 200, the prior art touch panel 200 will still be inactive. As illustrated in FIG. 1(c), when the distance between the finger 300 and the prior art PCT panel 200 is further reduced to D3=0, i.e., the finger 300 is in contact with the prior art PCT panel 200, an induced signal higher than the threshold will be generated on an equivalent capacitor of a sensing area of the prior art PCT panel 200, and the prior art PCT panel 200 will be active to process the touch action.

In processing the touch action, the prior art PCT panel 200 generally employs a fixed resolution, a fixed scan frequency, and a high signal gain. However, using a fixed resolution and a fixed scan frequency to detect the finger 300 posed at all the distances like D1, D2, D3 from the PCT panel 200, will cause the PCT panel 200 consuming power both in operation and in standby, and the setting of the threshold has to go through a time consuming process to overcome the dynamic interference coming from a LCD module or a circuit system.

Please refer to FIG. 2(a) and FIG. 2(b), wherein FIG. 2(a) illustrates the operation of a prior art PCT panel using self-capacitors for Z-axis sensing; FIG. 2(b) illustrates the operation of a prior art PCT panel using mutual-capacitors for Z-axis sensing. Although a prior art PCT panel 400 can use self-capacitors to provide a Z-axis sensing function as illustrated in FIG. 2(a), however it has the following disadvantages: 1. it has a fixed sensor resolution; 2. it can detect only a single approached point when in non-contact operation; 3. it requires two sets of detection circuits and calculation algorithms; and 4. it consumes power when standby. Although the prior art PCT panel 400 can also use mutual-capacitors to provide a Z-axis sensing function as illustrated in FIG. 2(b), however it still has the following disadvantages: 1. it has a fixed sensor resolution; 2. it has multiple projected points when a finger 300 is approaching; 3. it requires two sets of detection circuits and calculation algorithms; and 4. it consumes power when standby.

Besides, the prior art PCT panel has only a default signal gain and a fixed threshold. Please refer to FIG. 3, which illustrates a prior art PCT panel 200 using a default gain to amplify a signal induced by a finger 300 at a distance D1. As illustrated in FIG. 3, with the default gain, when the finger is at the distance D1, since the induced signal on the equivalent capacitor of a sensing area is still lower than a threshold, the prior art PCT panel 200 will be inactive; and the prior art PCT panel 200 will be active only when the finger is almost in contact with it to make the induced signal higher than the threshold.

### SUMMARY OF THE INVENTION

One objective of the present invention is to provide a dynamic control method for a touch panel, which can dynamically adjust the resolution of the touch panel.

Another objective of the present invention is to provide a dynamic control method for a touch panel, which can dynamically adjust the signal gain of the touch panel.

Another objective of the present invention is to provide a dynamic control method for a touch panel, which can dynamically adjust the scan frequency of the touch panel.

Another objective of the present invention is to provide a dynamic control method for a touch panel, which can dynamically adjust the active threshold of the touch panel.

Still another objective of the present invention is to provide a dynamic control method for a touch panel, of which a dynamic control mechanism with properly configured parameters not only can reduce the response time and power consumption of the touch panel, but also can provide a versatile GUI (Graphical User Interface) by detecting Z-axis approaching actions of an object.

To attain the foregoing objectives, the present invention proposes a dynamic control method for a touch panel, the method including the steps of: providing a dynamic resolution control circuit for configuring a touch panel to possess a first resolution and a second resolution; and providing an induced signal gain control circuit for configuring the touch panel to have a first gain corresponding to the first resolution, and a second gain corresponding to the second resolution, wherein, the resolution of the touch panel will change from the first resolution to the second resolution when an object is within a distance from the touch panel.

To attain the foregoing objectives, the present invention proposes another dynamic control method for a touch panel, the method including: providing a first stage, in which a touch panel operates with a first gain and a first scan frequency; and providing a second stage, in which the touch panel reduces the sensing area and operates with a second gain and a second scan frequency for locating an approached block, so as to facilitate a coordinate calculation of a touched point of the touch panel, wherein the touch panel will move from the first stage to the second stage when an object is within a distance from the touch panel.

To attain the foregoing objectives, the present invention proposes a touch panel system, including: a touch panel, having a glass, a sensor array and a display panel, wherein the sensor array is placed over one side of the glass for generating a sensing signal in response to an approaching movement of an object, and the glass is placed over the display panel; a dynamic resolution control circuit, coupled to the sensor array and used for configuring the touch panel to possess a first resolution and a second resolution, and thereby output an X-Y plane coordinate signal, wherein the resolution of the touch panel will change from the first resolution to the second resolution when the object is within a distance from the touch panel; an induced signal gain control circuit, coupled to the dynamic resolution control circuit and used for providing a first gain and a second gain corresponding to the first resolution and the second resolution respectively, so as to amplify the X-Y plane coordinate signal to generate an analog signal; an analog to digital conversion circuit, coupled to the induced signal gain control circuit and used for performing an analog to digital conversion on the analog signal to generate a digital signal; a digital signal processor, coupled to the analog to digital conversion circuit and used for processing the digital signal to generate a digital X-Y plane coordinate signal; and a controller, coupled to the digital signal processor and used for conveying the digital X-Y plane coordinate signal to a graphical user interface for executing a corresponding instruction.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1(a) illustrates the operation of a prior art PCT (Projected Capacitive Touch) panel by a finger at distances D1.

FIG. 1(b) illustrates the operation of a prior art PCT (Projected Capacitive Touch) panel by a finger at distances D2.

FIG. 1(c) illustrates the operation of a prior art PCT (Projected Capacitive Touch) panel by a finger at distances D3.

FIG. 2(a) illustrates the operation of a prior art PCT panel using self-capacitors for Z-axis sensing.

FIG. 2(b) illustrates the operation of a prior art PCT panel using mutual-capacitors for Z-axis sensing.

FIG. 3 illustrates a prior art PCT panel using a default gain to amplify a signal induced by a finger at a distance D1.

FIG. 4 illustrates the flow chart of a dynamic control method for a touch panel according to a preferred embodiment of the present invention.

FIG. 5(a) illustrates a first preferred embodiment of the present invention's dynamic control method operating in a first stage having a resolution of 2×3.

FIG. 5(b) illustrates the first preferred embodiment of the present invention's dynamic control method operating in a second stage having 6×3 blocks with each block capable of being divided into 10×5 sensing elements.

FIG. 6(a) illustrates a second preferred embodiment of the present invention's dynamic control method operating in a first stage having a resolution of 1×1.

FIG. 6(b) illustrates the second preferred embodiment of the present invention's dynamic control method operating in a second stage having 6×3 blocks with each block capable of being divided into 10×5 sensing elements.

FIG. 7 illustrates the operation of a preferred embodiment of the present invention's dynamic control method on a touch panel for adjusting the gain for a signal induced by a finger at a distance D1.

FIG. 8(a) illustrates a preferred embodiment of the present invention's dynamic control method for a touch panel operating in a first stage having a first threshold.

FIG. 8(b) illustrates the preferred embodiment of the present invention's dynamic control method for the touch panel operating in a second stage having a second threshold.

FIG. 9(a) illustrates a preferred embodiment of the present invention's dynamic control method providing a high sensitivity for a touch panel in a first stage.

FIG. 9(b) illustrates the preferred embodiment of the present invention's dynamic control method providing a high sensitivity for the touch panel in a second stage.

FIG. 9(c) illustrates the preferred embodiment of the present invention's dynamic control method providing a normal sensitivity for the touch panel in a third stage.

FIG. 10 illustrates the block diagram of a touch panel system according to a preferred embodiment of the present invention.

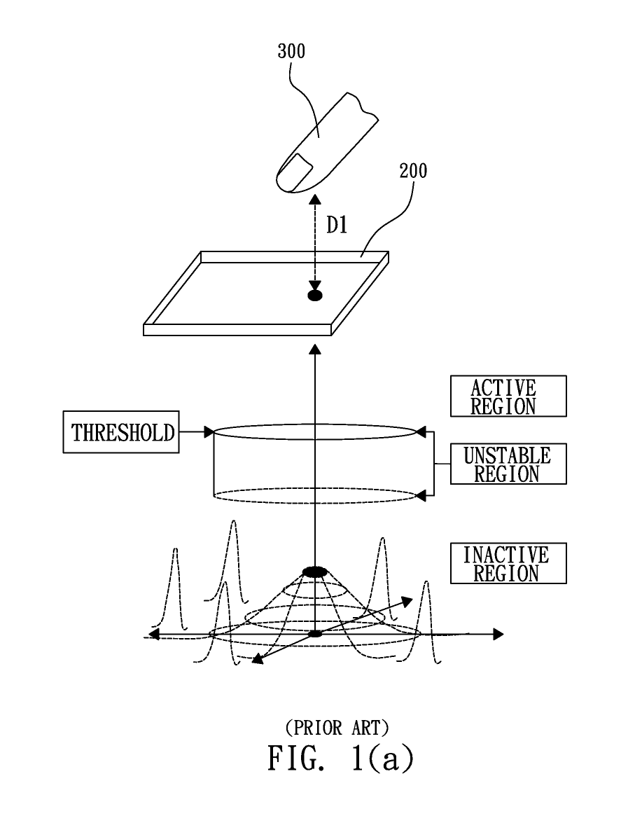

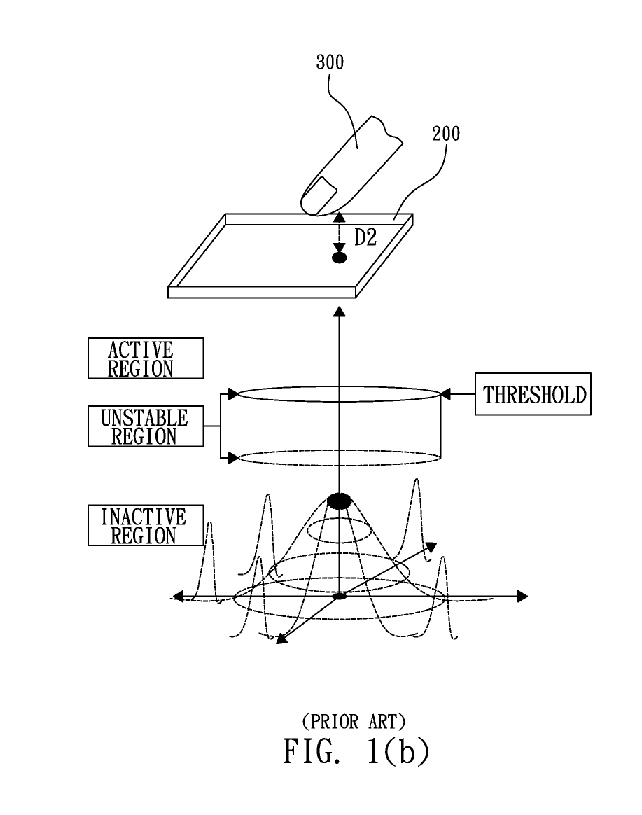

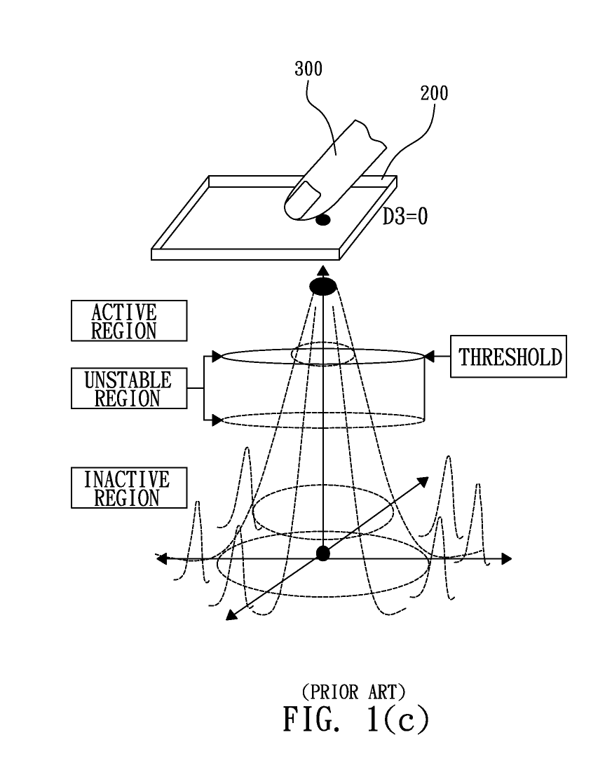

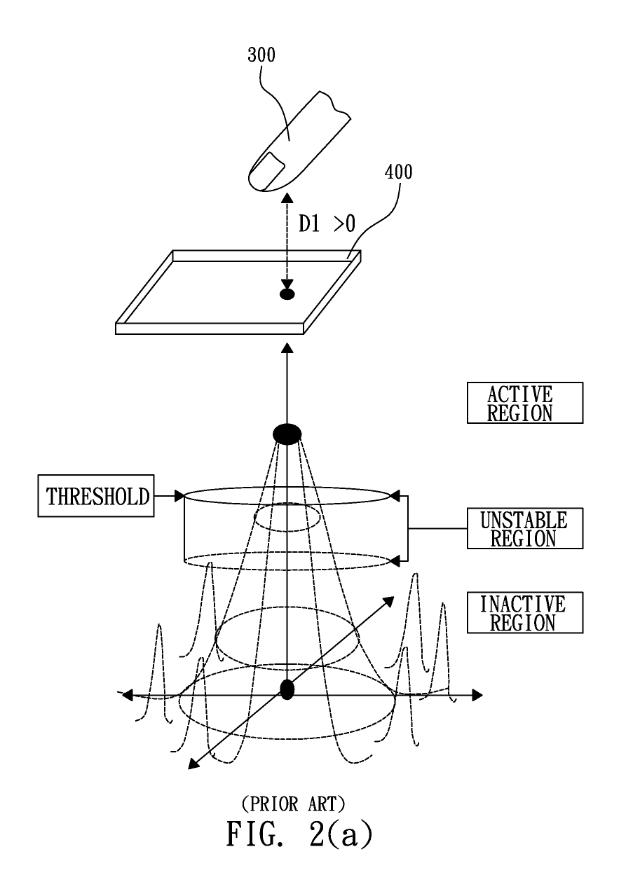

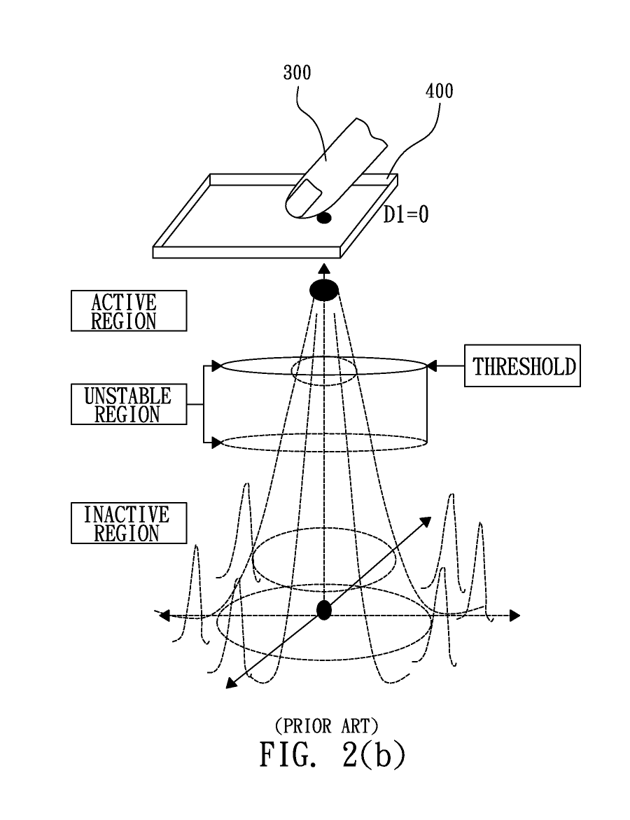

### DETAILED DESCRIPTION OF THE PREFERRED EMBODIMENTS

The present invention will be described in more detail hereinafter with reference to the accompanying drawings that show the preferred embodiments of the invention.

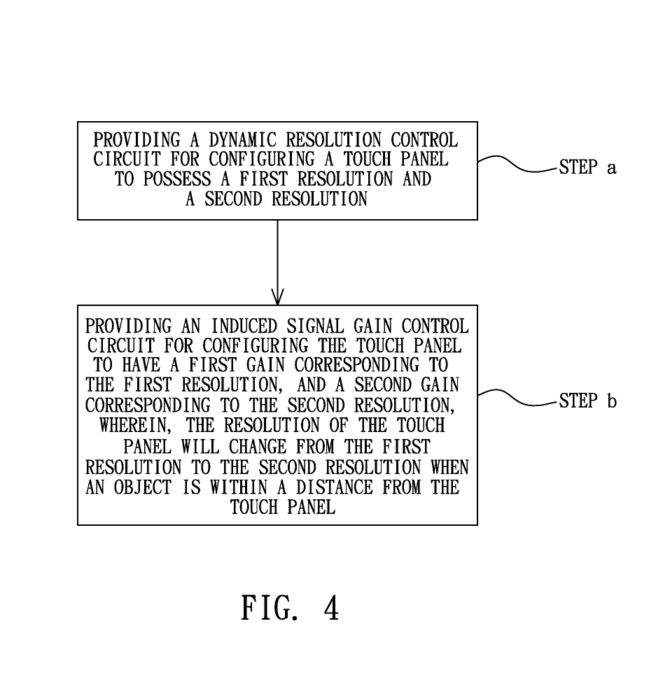

Please refer to FIG. 4, which illustrates the flow chart of a dynamic control method for a touch panel according to a preferred embodiment of the present invention. As illustrated in the figure, the dynamic control method for a touch panel of the present invention uses two operation steps for illustration, which is not meant to be limited thereto, and the steps are as follows: providing a dynamic resolution control circuit for configuring a touch panel to possess a first resolution and a second resolution (step a); and providing an induced signal gain control circuit for configuring the touch panel to have a first gain corresponding to the first resolution, and a second gain corresponding to the second resolution, wherein, the resolution of the touch panel will change from the first resolution to the second resolution when an object is within a distance from the touch panel (step b).

In step a, the dynamic resolution control circuit will cause the touch panel to change the resolution from a first resolution to a second resolution when an object is within a first distance from the touch panel; wherein, the object can be for example but not limited to a finger or a touch stylus having a conductive tip; the touch panel can be for example but not limited to a capacitive touch panel, which can be a self-capacitor type touch panel or a mutual-capacitor type touch panel, and capable of multi-touch sensing. The first distance is for example but not limited to 2 cm; the first resolution is for example but not limited to 1×1 or 2×3; the second resolution is for example but not limited to have 6×3 blocks, with each block capable of being further divided into 10×5 sensing elements. When configured to have the first resolution, the touch panel will have a high sensitivity and a low scan frequency (for example but not limited to a LCD frame rate—once per 1/60 sec); and when configured to have the second resolution, the touch panel will have a low sensitivity and a high scan frequency (for example but not limited to 100 times per 1/60 sec).

In step b, the gain control circuit configures the touch panel to have a first gain corresponding to the first resolution and a second gain corresponding to the second resolution, wherein the resolution of the touch panel will change from the first resolution to the second resolution when an object is within a distance from the touch panel. The gain control circuit is an analog signal gain control circuit, and the first gain is larger than the second gain. Besides, when the touch panel is in the second resolution, the dynamic resolution control circuit will further configure the touch panel to form a maximum resolution and use basic sensing elements to finally detect the coordinates of the touch locations after the object is in contact with the touch panel. In addition, by such multi stages arrangement including resolution control, signal gain control, and scan frequency control, the touch system can also shun the interfering noise of the touch panel to provide a high signal to noise ratio (SNR).

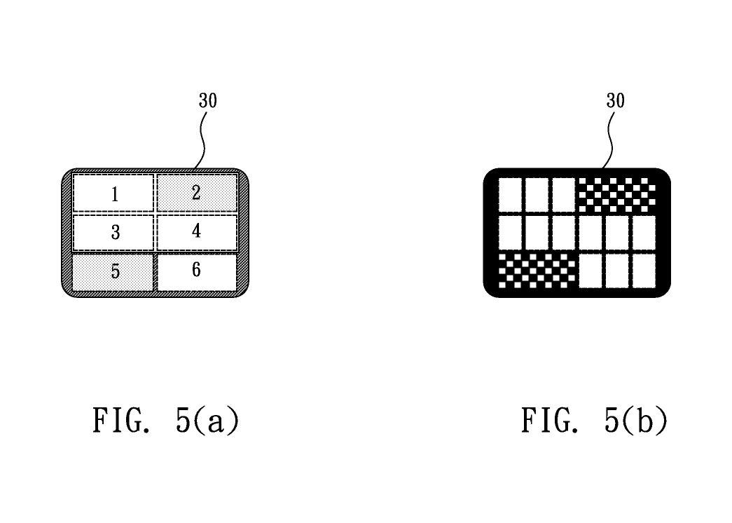

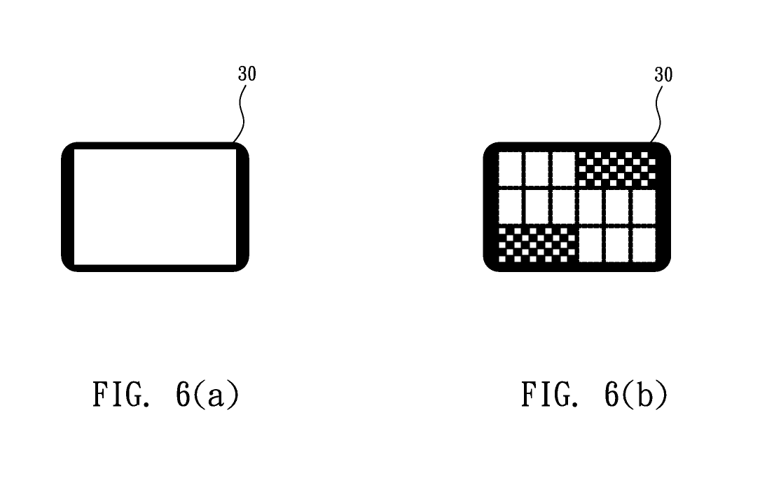

The operation principle of the present invention's dynamic control method will be further elaborated as follows. Please refer to FIG. 5(a)-6(b), wherein FIG. 5(a) and FIG. 5(b) illustrate a first preferred embodiment of the present invention's dynamic control method operating in a first stage having a resolution of 2×3, and operating in a second stage having 6×3 blocks with each block capable of being divided into 10×5 sensing elements respectively;

FIG. 6(a) and FIG. 6(b) illustrate a second preferred embodiment of the present invention's dynamic control method operating in a first stage having a resolution of 1×1, and operating in a second stage having 6×3 blocks with each block capable of being divided into 10×5 sensing elements respectively.

In the first preferred embodiment, when the distance between an object and a touch panel is larger than a predetermined distance, for example but not limited to 2 cm, a dynamic resolution control circuit will maintain the resolution of the touch panel at 2×3 as illustrated in FIG. 5(a). When the distance between the object and the touch panel is less than 2 cm, the dynamic resolution control circuit will enter a second stage to divide the touch panel into 6×3 blocks as illustrated in FIG. 5(b), with each approached block further divided into 10×5 sensing elements. Given the scan frequency at 60 Hz, as the dynamic resolution control circuit and a gain control circuit only have to operate on 2 (or n) approached ones in the 18 blocks when the object (a finger or a touch stylus) is in contact with the touch panel, there will be only 10×5×2 (or 10×5×n) sensing elements needed to be scanned in 1/60 sec, which makes the present invention much faster in finding the touch locations than the traditional method which finds the touch locations by scanning the whole touch plane in a point by point or line by line manner.

In the second preferred embodiment, when the distance between an object and a touch panel is larger than a predetermined distance, for example but not limited to 2 cm, a dynamic resolution control circuit will maintain the resolution of the touch panel at 1×1 as illustrated in FIG. 6(a). When the distance between the object and the touch panel is less than 2 cm, the dynamic resolution control circuit will enter a second stage as illustrated in FIG. 6(b). As the second stage illustrated in FIG. 6(b) is same as that in FIG. 5(b), it will not be readdressed here.

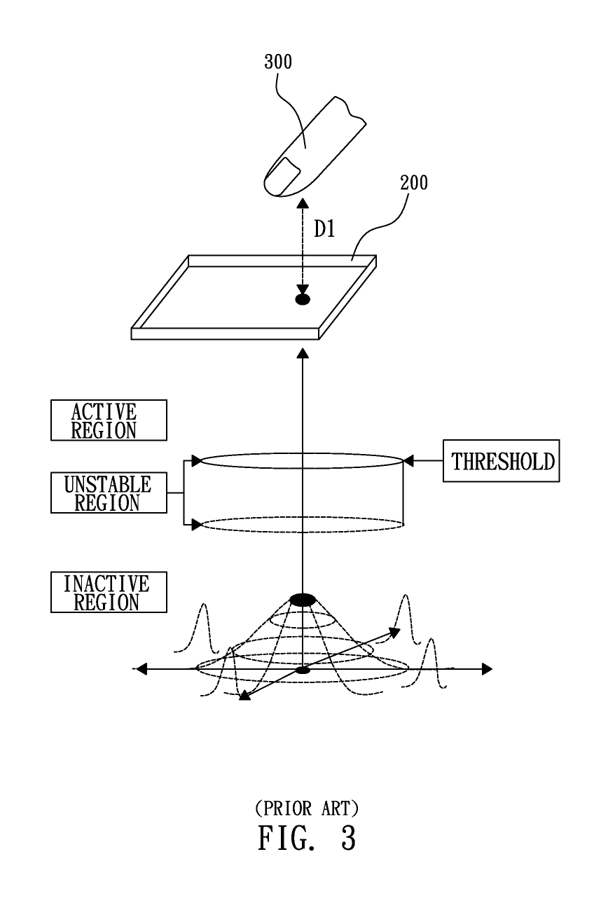

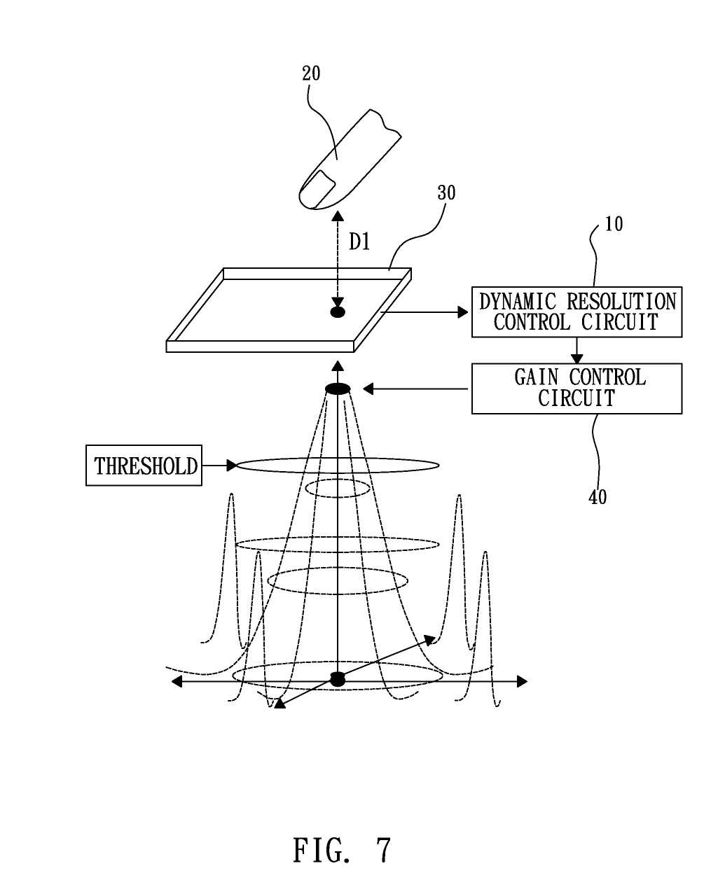

To further demonstrate how the dynamic control method of the present invention can make a touch panel possess a dynamic control function, the present invention proposes FIG. 7, which illustrates the operation of another preferred embodiment of the present invention's dynamic control method on a touch panel 30 for adjusting the gain for a signal induced by a finger 20 at a distance D1 from the touch panel 30. As illustrated in FIG. 7, with the finger 20 at same distance D1 as that in FIG. 3, the present invention can amplify the induced signal on the equivalent capacitor of a sensing region of the touch panel 30 by properly configuring a dynamic resolution control circuit 10 and the gain control circuit 40, so as to make the amplified induced signal higher than a threshold and become active, and thereby increase the sensitivity of the touch panel 30. The threshold can be a voltage, a current, or a count of pulses.

The dynamic control method for a touch panel in FIG. 7 can have different threshold values corresponding to different stages and different resolutions.

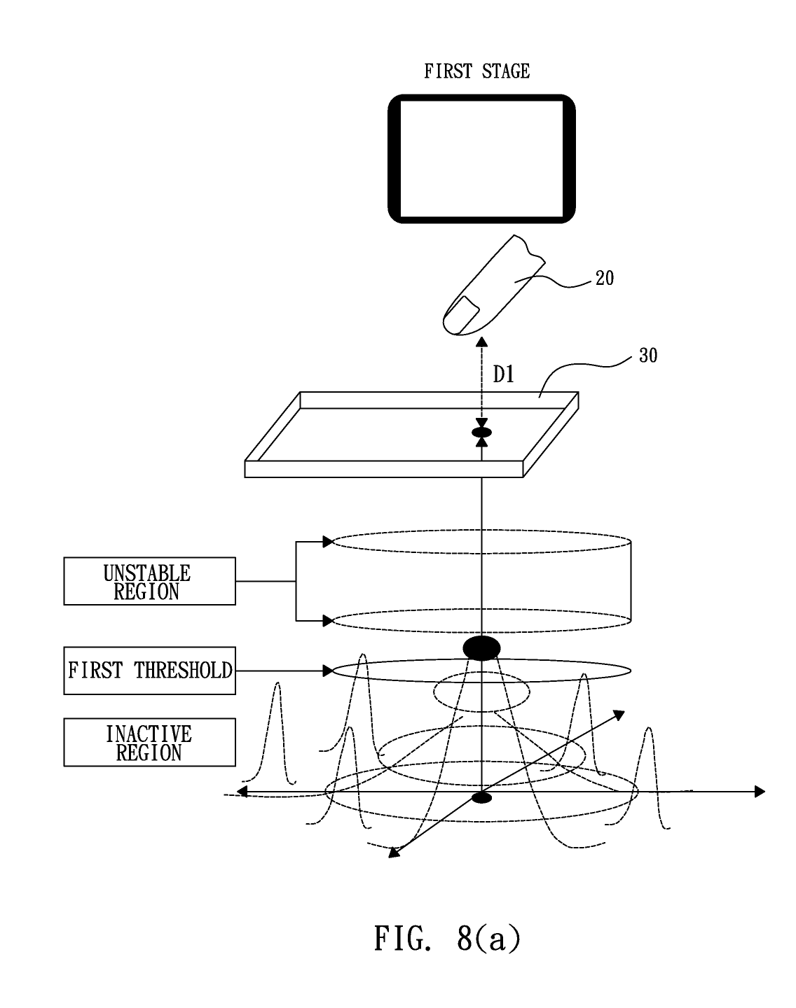

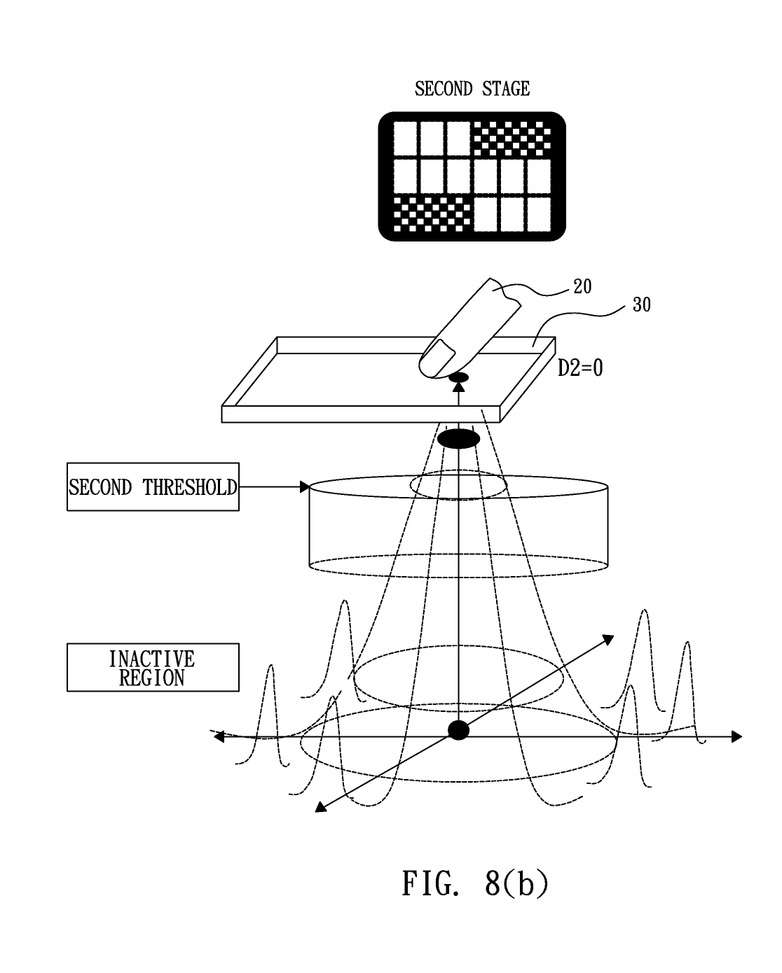

Please refer to FIG. 8(a)-8(b), wherein FIG. 8(a) illustrates a preferred embodiment of the present invention's dynamic control method for a touch panel operating in a first stage; FIG. 8(b) illustrates the preferred embodiment of the present invention's dynamic control method for the touch panel operating in a second stage.

As illustrated in FIG. 8(a), when in a first stage, the dynamic control method of the present invention for a touch panel 30 will have a first threshold at a low level, and the induced signal amplified by a first gain set by a dynamic resolution control circuit will be higher than the first threshold to indicate the approaching of an object 20 as the distance D1 of the object 20 from the touch panel 30 is within a first distance, and the touch panel will enter a second stage for touch locations detection. As illustrated in FIG. 8(b), when in the second stage, the dynamic control method of the present invention for the touch panel 30 will have a second threshold at a high level, and the induced signal amplified by a second gain set by the dynamic resolution control circuit will be higher than the second threshold to help locate the touch position of the object 20 as the object 20 is in contact with the touch panel 30. In the arrangement of the preferred embodiment of the present invention, the second threshold is higher than the second threshold. That is, the dynamic control method for a touch panel of the present invention adaptively adjusts the active conditions of the touch panel 30—the nearer the object 20 is from the touch panel 30, the higher the threshold and the lower the signal gain will be, so as to reduce noise and get the actual coordinates of the touch locations.

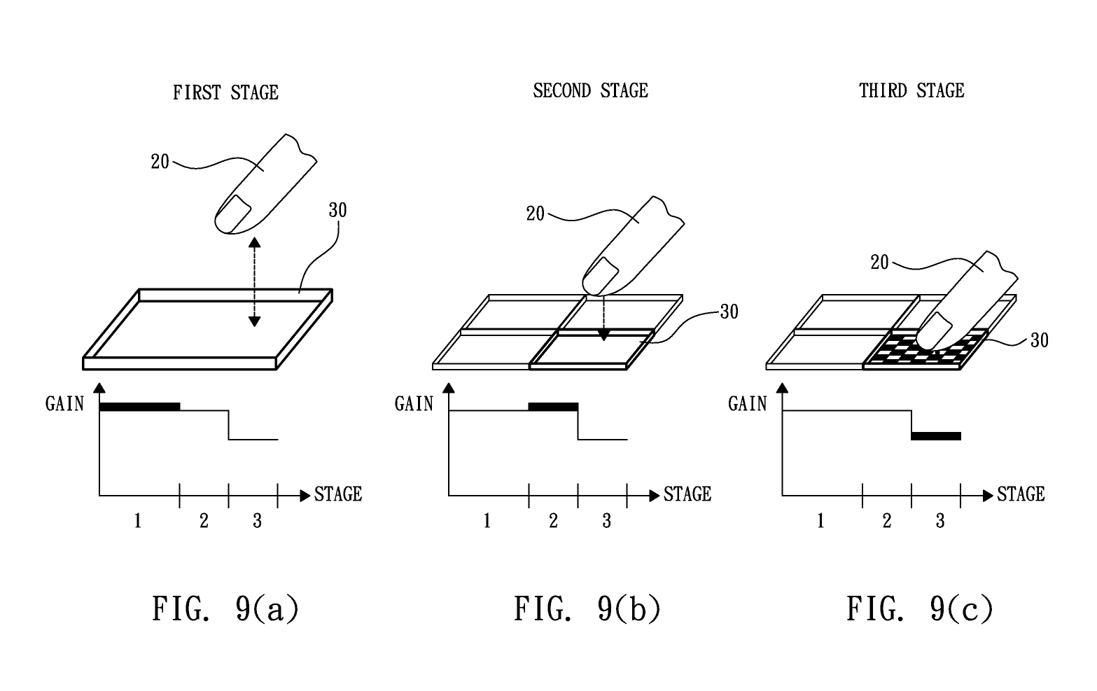

To further demonstrate the high sensitivity of the present invention in detecting an object approaching a touch panel in the vertical direction (Z-axis), the present invention proposes FIG. 9(a)-9(c), wherein FIG. 9(a) illustrates a preferred embodiment of the present invention's dynamic control method providing a high sensitivity for a touch panel 30 in a first stage; FIG. 9(b) illustrates the preferred embodiment of the present invention's dynamic control method providing a high sensitivity for the touch panel 30 in a second stage; FIG. 9(c) illustrates the preferred embodiment of the present invention's dynamic control method providing a normal sensitivity for the touch panel 30 in a third stage.

As illustrated in the figures, the preferred embodiment of the present invention's dynamic control method having three stages for adjusting the sensitivity of the touch panel 30 includes the steps of: configuring the touch panel 30 to have a first gain and a first scan frequency in a first stage, and entering a second stage when an object 20 is within a distance from the touch panel 30 (step a); and configuring the touch panel 30 to have smaller sensing areas, a second gain, and a second scan frequency in the second stage for locating approached sensing areas, and entering a third stage when an object 20 is in contact with the touch panel 30 to calculate the coordinates of the touch locations (step b).

In step a, the touch panel 30 is configured to have the first gain and the first scan frequency in the first stage (as illustrated in FIG. 9(a)), and will enter the second stage when the object 20 is within a distance from the touch panel 30 (as illustrated in FIG. 9(b)), wherein, the distance is for example but not limited to 2 cm, and the resolution of the touch panel 30 is for example but not limited to 1×1 or 2×3, to achieve high sensitivity and power saving.

In step b, the touch panel 30 will eventually switch to have minimum sensing areas (i.e., the basic sensing elements), a low gain, and a high scan frequency (as illustrated in FIG. 9c), so as to get the coordinates of the touch locations when the object 20 is in contact with the touch panel 30. In the third stage, the touch panel 30 has, for example, 6×3 blocks, and each block has, for example, 10×5 basic sensing elements. When the object 20 is in contact with the touch panel 30, the touch panel 30 will use the basic sensing elements, the low gain (to avoid amplifying the accompanying noise), and the high scan frequency to perform a precise touch location calculation.

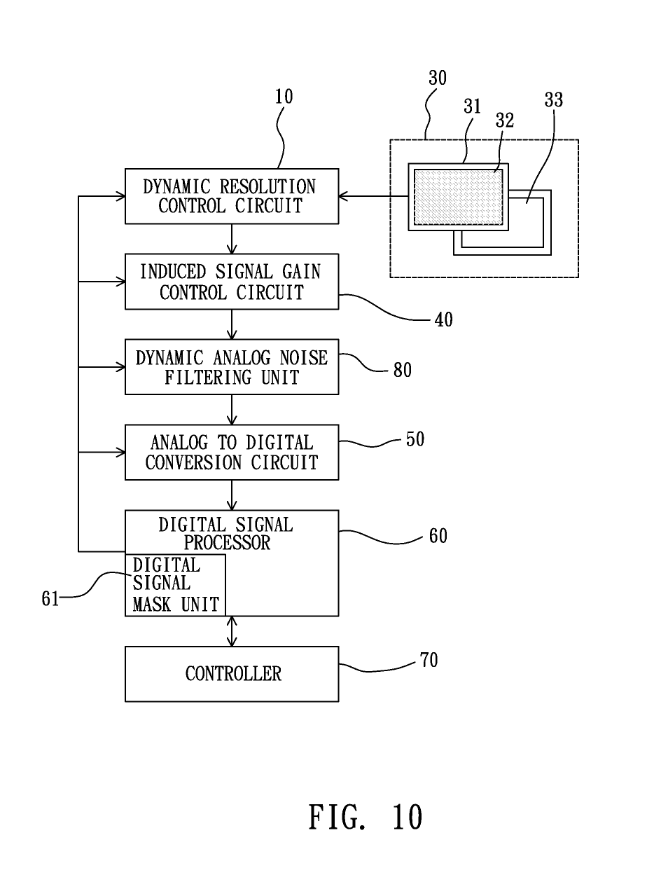

Please refer to FIG. 10, which illustrates the block diagram of a touch panel system according to a preferred embodiment of the present invention. As illustrated in the figure, the touch panel system includes a touch panel 30, a dynamic resolution control circuit 10, an induced signal gain control circuit 40, an analog to digital conversion circuit 50, a digital signal processor 60, and a controller 70.

In the system, the touch panel 30 has a glass 31, a sensor array 32, and a display panel 33, wherein the sensor array 32 is placed over one side of the glass 31, for example, above or below the glass 31, to generate an induced signal in response to the approaching of the object 20, wherein the induced signal can be a voltage, a current, or a count of pulses. The sensor array 32 can be for example but not limited to of mutual-capacitor type or self-capacitor type, and the number of sensing elements is determined by the resolution. For example, when the touch panel 30 has 6×3 blocks and each block has a resolution of 10×5, then the number of the sensing elements in the sensor array 32 will be 6×3×10×5. The glass 31 is placed over the display panel 33, and the display panel 33 is for example but not limited to a TFT display panel.

The dynamic resolution control circuit 10 is coupled to the sensor array 32 and capable of making the touch panel 30 possess a first resolution and a second resolution, and output an X-Y plane coordinates signal. When the object 20 is within a distance, for example 2 cm, from the touch panel 30, the resolution of the touch panel 30 will change from the first resolution to the second resolution, wherein the first resolution is for example 1×1 or 2×3, and the second resolution includes for example 6×3 blocks with each block capable of being further divided into 10×5 sensing elements. As the principle of the resolutions switching has been elaborated above, it will not be readdressed here.

The induced signal gain control circuit 40 is coupled to the dynamic resolution control circuit 10 for providing a first gain corresponding to the first resolution and a second gain corresponding to the second resolution, so as to amplify the X-Y plane coordinate signal to generate an analog signal, wherein the first gain is larger than the second gain. As the principle of the gain control has been elaborated above, it will not be readdressed here.

The analog to digital conversion circuit 50 is coupled to the induced signal gain control circuit 40 for performing an analog to digital conversion on the analog signal to generate a digital signal.

The digital signal processor 60 is coupled to the analog to digital conversion circuit 50 for processing the digital signal to generate a digital X-Y plane coordinate signal, wherein, the digital signal processor 60 further includes a digital signal mask unit 61 for providing a one dimension convolution mask function for the touch panel 30 in the first resolution, and a two dimension convolution mask function for the touch panel 30 in the second resolution. The digital signal processor 60 can be for example but not limited to a micro controller, a DSP chip, or an SOC chip.

The formula for the one dimension convolution mask is:

y[n]=Σx[k]·h[n−k], wherein y[n] represents the convolution output, Σx[k] represents the output of the induced signal gain control circuit 40, and h[n−k] stands for the kernel of the one dimension mask.

The formula for the one dimension convolution mask is:

y(m,n)=ΣΣx(m+i,n+j)h(i,j), wherein y[m,n] represents the convolution output, ΣΣx(m+l,n+j) represents the output of the induced signal gain control circuit 40, and h(I,j) stands for the kernel of the two dimension mask.

The controller 70 is coupled to the digital signal processor 60 for conveying the digital X-Y plane coordinate signal to a graphical user interface (GUI) for executing a corresponding instruction, wherein the controller 70 is for example but not limited to a SOC chip.

Preferably, the touch panel system further includes a dynamic analog noise filtering unit 80, coupled between the induced signal gain control circuit 40 and the analog to digital conversion circuit 50, so as to provide a first order low-pass filtering function for the touch panel 30 in the first resolution, and a second order band-pass filtering function for the touch panel 30 in the second resolution.

In virtue of the novel design specified above, the present invention's dynamic control method for a touch panel possesses the following advantages: 1. it is capable of adaptively adjusting the touch panel's resolution; 2. it is capable of adjusting the touch panel's signal gain adaptively, 3. it is capable of adjusting the touch panel's scan frequency adaptively, and 4. it is capable of adjusting the touch panel's active threshold adaptively. The dynamic control method for a touch panel of the present invention therefore greatly improves the prior art PCT panel.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

1. A dynamic control method for a touch panel, the method comprising the steps of:
providing a dynamic resolution control circuit for configuring a touch panel to possess a first resolution and a second resolution; and
providing an induced signal gain control circuit for configuring said touch panel to have a first gain corresponding to said first resolution, and a second gain corresponding to said second resolution, wherein, the resolution of said touch panel will change from said first resolution to said second resolution when an object is within a distance from said touch panel.

2. The dynamic control method for a touch panel as disclosed in claim 1, wherein said distance is 2 cm, said first resolution is 2×3, and said second resolution has 6×3 blocks with each said block capable of being divided into 10×5 sensing elements.

3. The dynamic control method for a touch panel as claim 1, wherein said distance is 2 cm, said first resolution is 1×1, and said second resolution has 6×3 blocks with each said block capable of being divided into 10×5 sensing elements.

4. The dynamic control method for a touch panel as claim 3, wherein when said touch panel is in said second resolution, said dynamic resolution control circuit will further configure said touch panel to form a maximum resolution and use basic sensing elements to finally detect the coordinates of touch locations after said object is in contact with said touch panel.

5. The dynamic control method for a touch panel as claim 4, wherein said touch panel has a high sensitivity and a low scan frequency when in said first resolution, and a low sensitivity and a high scan frequency when in said second resolution.

6. The dynamic control method for a touch panel as claim 1, wherein said gain control circuit is an analog signal gain control circuit, and said first gain is larger than said second gain.

7. The dynamic control method for a touch panel as disclosed in claim 1, wherein said object is a finger or a touch stylus having a conductive tip.

8. The dynamic control method for a touch panel as claim 1, wherein said induced signal gain control circuit can further amplify a signal on the equivalent capacitor of a sensing block of said touch panel induced by said object at said distance, to exceeding a threshold and entering an active region, so as to promote the sensitivity of said touch panel, wherein said threshold is a voltage, a current, or a count of pulses.

9. The dynamic control method for a touch panel as claim 1, wherein said induced signal gain control circuit further provides a first threshold corresponding to said first resolution, and a second threshold corresponding to said second resolution.

10. The dynamic control method for a touch panel as claim 9, wherein said first threshold is lower than said second threshold, and the resolution and the threshold of said touch panel are adaptively adjusted when said object is approaching said touch panel.

11. A dynamic control method for a touch panel, the method comprising the steps of:
providing a first stage, in which a touch panel operates with a first gain and a first scan frequency; and
providing a second stage, in which said touch panel reduces the sensing area and operates with a second gain and a second scan frequency for locating an approached block, so as to facilitate a coordinate calculation of a touched point of said touch panel, wherein said touch panel will move from said first stage to said second stage when an object is within a distance from said touch panel.

12. The dynamic control method for a touch panel as disclosed in claim 11, wherein said distance is 2 cm, and when in said first stage, said first resolution is 2×3, and when in said second stage, said second resolution has 6×3 blocks with each said block capable of being divided into 10×5 sensing elements.

13. The dynamic control method for a touch panel as claim 11, wherein said distance is 2 cm, and when in said first stage, said first resolution is 1×1, and when in said second stage, said second resolution has 6×3 blocks with each said block capable of being divided into 10×5 sensing elements.

14. A touch panel system, comprising:
a touch panel, having a glass, a sensor array and a display panel, wherein said sensor array is placed over one side of said glass for generating a sensing signal in response to an approaching movement of an object, and said glass is placed over said display panel;
a dynamic resolution control circuit, coupled to said sensor array and used for configuring said touch panel to possess a first resolution and a second resolution, and thereby output an X-Y plane coordinate signal, wherein the resolution of said touch panel will change from said first resolution to said second resolution when said object is within a distance from said touch panel;
an induced signal gain control circuit, coupled to said dynamic resolution control circuit and used for providing a first gain and a second gain corresponding to said first resolution and said second resolution respectively, so as to amplify said X-Y plane coordinate signal to generate an analog signal;
an analog to digital conversion circuit, coupled to said induced signal gain control circuit and used for performing an analog to digital conversion on said analog signal to generate a digital signal;
a digital signal processor, coupled to said analog to digital conversion circuit and used for processing said digital signal to generate a digital X-Y plane coordinate signal; and
a controller, coupled to said digital signal processor and used for conveying said digital X-Y plane coordinate signal to a graphical user interface for executing a corresponding instruction.

15. The touch panel system as disclosed in claim 14, wherein said distance is 2 cm, said first resolution is 2×3, and said second resolution has 6×3 blocks with each said block capable of being divided into 10×5 sensing elements.

16. The touch panel system as claim 14, wherein said distance is 2 cm, said first resolution is 1×1, and said second resolution has 6×3 blocks with each said block capable of being divided into 10×5 sensing elements.

17. The touch panel system as disclosed in claim 16, wherein said first gain is larger than said second gain.

18. The touch panel system as claim 14, wherein said object is a finger or a touch stylus having a conductive tip, said sensor array is placed above or below said glass, and said sensing signal is a voltage, a current, or a count of pulses.

19. The touch panel system as claim 14, further comprising a dynamic analog noise filtering unit, coupled between said induced signal gain control circuit and said analog to digital conversion circuit, so as to provide a first order low-pass filtering function for said touch panel with said first resolution, and a second order band-pass filtering function for said touch panel with said second resolution.

20. The touch panel system as claim 19, wherein said digital signal processor further comprises a digital signal mask unit, coupled to said dynamic analog noise filtering unit for providing a one dimension convolution mask function for said touch panel with said first resolution, and a two dimension convolution mask function for said touch panel with said second resolution.
